(19) United States
(12) Patent Application Publication
(10) Pub. No.: US 2003/0199280 A1
(43) Pub. Date: Oct. 23, 2003

(54) Method and system for receiving global positioning system signals

(75) Inventor: Wei-Chung Shih, Taoyuan City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENO CORPORATION

(21) Appl. No.: 10/410,016

(22) Filed: Apr. 8, 2003

(30) Foreign Application Priority Data
Apr. 19, 2002 (TW) 91108068

(51) Int. Cl. H04Q 7/20

(52) U.S. Cl. 455/456.1; 455/456.3

(57) ABSTRACT

A system for receiving global positioning system signals. The system comprises a mobile telecommunication device and a terminal device. The mobile telecommunication device comprises a first receiving interface and a transmission interface. A global positioning system signal is received by the first receiving interface. The global positioning system signal is transmitted by the transmission interface. The terminal device comprises a second receiving interface, an electronic map system and a display device. The global positioning system signal transmitted from the mobile telecommunication device is received by the second receiving interface. The electronic map system combines the global positioning system signal and an electronic map to produce information in graphic mode. The graphic information is displayed on the display device.

### BACKGROUND OF THE INVENTION

1. Field of the Invention

The present invention relates in general to a method and a system for receiving global positioning system (GPS) signals. In particular, the present invention relates to a method and a system which combines a mobile telecommunication device and a terminal device for receiving global positioning system signals.

2. Description of the Related Art

Global Positioning System (GPS) provides grid location easily with a GPS receiver. FIG. 1 is a conventional GPS receiver 10 which comprises a monitor 14. The GPS receiver 10 receives a GPS signal. By utilizing software 12 in the GPS receiver 10, the GPS receiver finds a location corresponding to the GPS signal on an electric map (not shown) and displays the location on the monitor 14.

The GPS receiver requires precision software and electric maps for GPS system. Some maps containing older information are not suitable for use in GPS systems. With the improvement of GPS tools and application software, a geographic information system (GIS) processes, calculates and displays information for a geographical graphic database. In the system, a high-performance operational device with large storage and memory capacity is required. FIG. 2 shows the configuration of the system for receiving GPS signals. The system 20 comprises a GPS receiver 22 and a notebook 24. The GPS receiver 22 receives a GPS signal and transmits the GPS signal to the notebook 24. The notebook 24 comprises software (not shown) for processing, calculating and displaying the GPS signal. After processing the GPS signal, the software finds a location corresponding to the GPS signal on an electric map (not shown) and displays the location on the monitor 26.

Users can only utilize the system with a GPS receiver, which can be inconvenient and costly.

Users can also utilize mobile telecommunication devices to receive GPS signals. However, mobile telecommunication devices are limited in their operational ability, normally being unable to find locations corresponding to the GPS signals on the electric map. Most mobile telecommunication devices can only display digital grid reference data. The digital data is not specific or friendly for users.

### SUMMARY OF THE INVENTION

An object of the present invention is to provide a system which combines a mobile telecommunication device (such as mobile phone) and a terminal device (such as notebook) for receiving global positioning system signals, without the need for a dedicated GPS receiver.

Another object of the present invention is to provide a method for combining GPS signals received by a mobile telecommunication device and an electric map in a terminal device to produce information in graphic mode. The graphic information displayed on the terminal device has dramatically increased usability.

The system for receiving global positioning system signals comprises a mobile telecommunication device and a terminal device. The mobile telecommunication device comprises a first receiving interface and a transmission interface. A global positioning system signal is received by the first receiving interface and is transmitted by the transmission interface. The terminal device comprises a second receiving interface, an electronic map system and a display device. The global positioning system signal transmitted from the mobile telecommunication device is received by the second receiving interface. The electronic map system combines the global positioning system signal and an electronic map to produce information in graphic mode. The graphic information is displayed on the display device.

The transmission interface and the second receiving interface may be a wired transmission interface such as USB, or a wireless transmission interface such as Bluetooth.

Furthermore, the invention also provides a method for receiving global positioning system signals. At first, a global positioning system signal is received by a mobile telecommunication device. Next, the global positioning system signal is transmitted from the mobile telecommunication device to a terminal device which comprises an electronic map. Then, the global positioning system signal and an electronic map are combined to produce information in graphic mode. Finally, the graphic information is displayed on a display device.

Transmitting the global positioning system signal from the mobile telecommunication device to a terminal device may use a wired transmission interface such as USB or wireless transmission interface such as Short-range wireless communication interface.

### BRIEF DESCRIPTION OF THE DRAWINGS

The present invention can be more fully understood by reading the subsequent detailed description in conjunction with the examples and references made to the accompanying drawings, wherein:

FIG. 1 is a conventional GPS receiver which comprises monitor;

FIG. 2 shows the configuration of the system for receiving GPS signals in the prior art;

FIG. 3a shows the configuration of the system for receiving GPS signals according to a first embodiment of the present invention;

FIG. 3b is a block diagram of an example of the mobile telecommunication device of FIG. 3a;

FIG. 3c is a block diagram of an example of the terminal device of FIG. 3a;

FIG. 4a shows the configuration of the system for receiving GPS signals according to a second embodiment of the present invention;

FIG. 4b is a block diagram of an example of the mobile telecommunication device of FIG. 4a; and

FIG. 4c is a block diagram of an example of the terminal device of FIG. 4a.

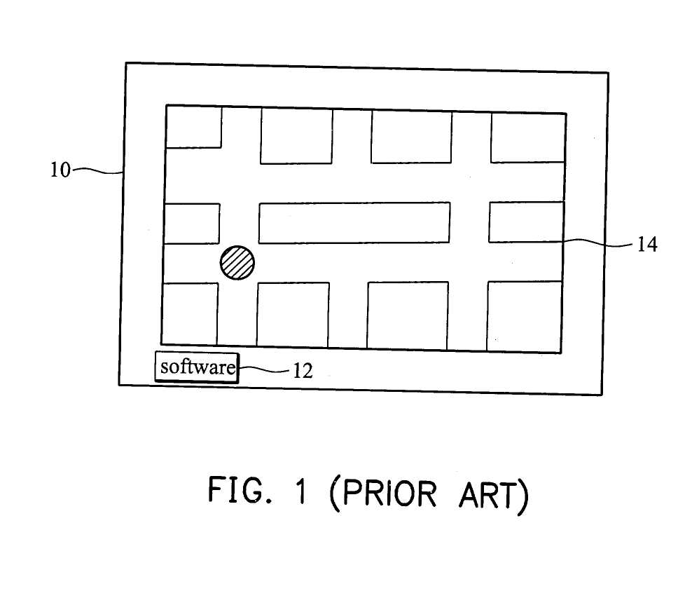

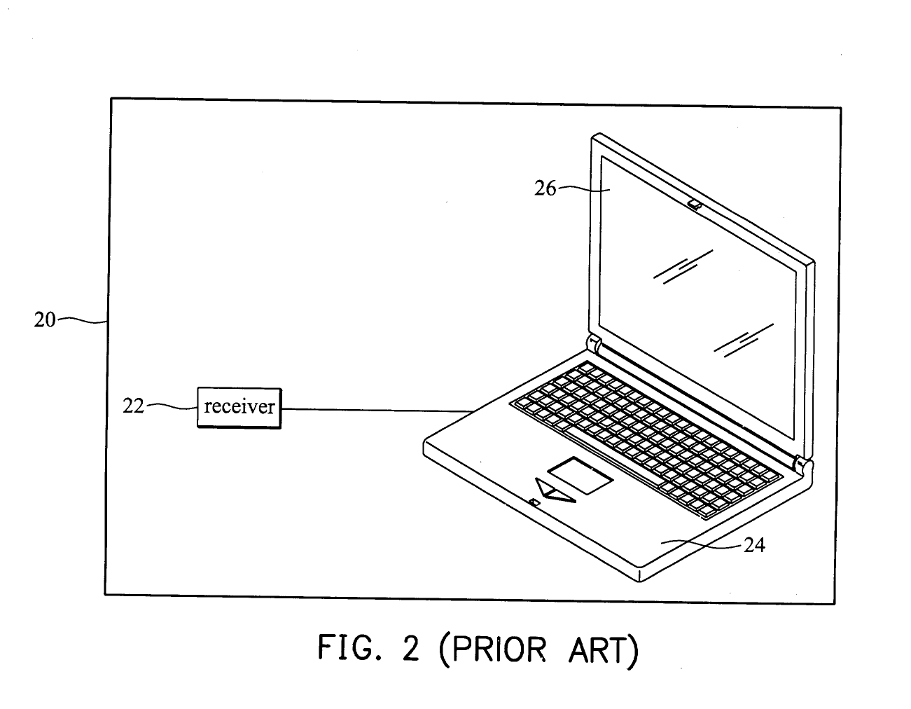

### DETAILED DESCRIPTION OF THE INVENTION

The invention provides a system which combines a mobile telecommunication device and a terminal device for receiving global positioning system signals. The global positioning system signals are received by mobile telecommunication devices. The global positioning system signals are processed, calculated, and displayed in the terminal device. The invention also provides a method for combining GPS signals received by the mobile telecommunication device and an electric map in the terminal device to produce information in graphic mode. Through the following description, the embodiments of the present invention can be understood in conjunction with the accompanying drawings.

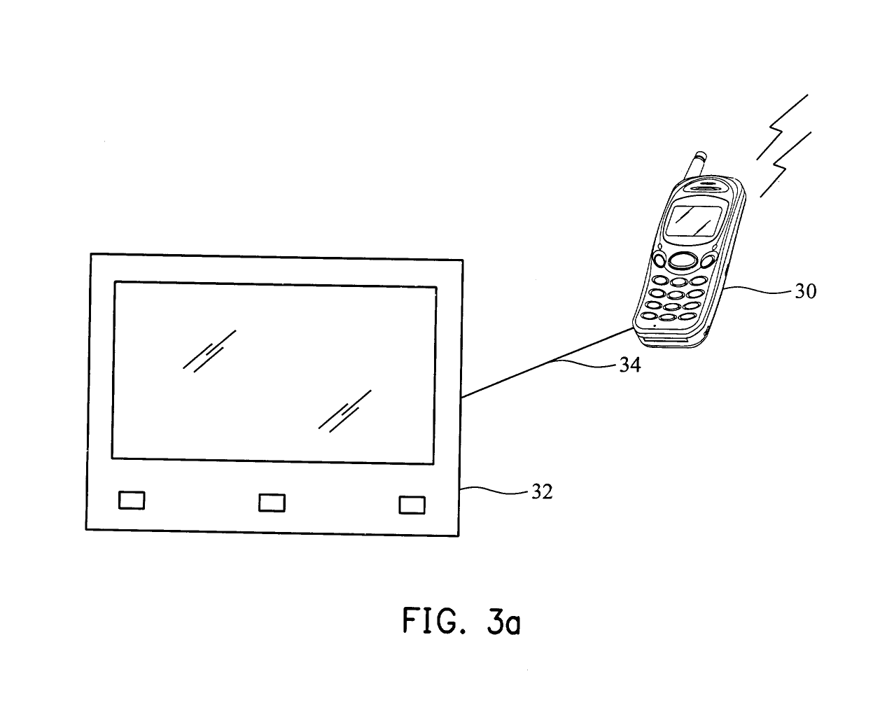

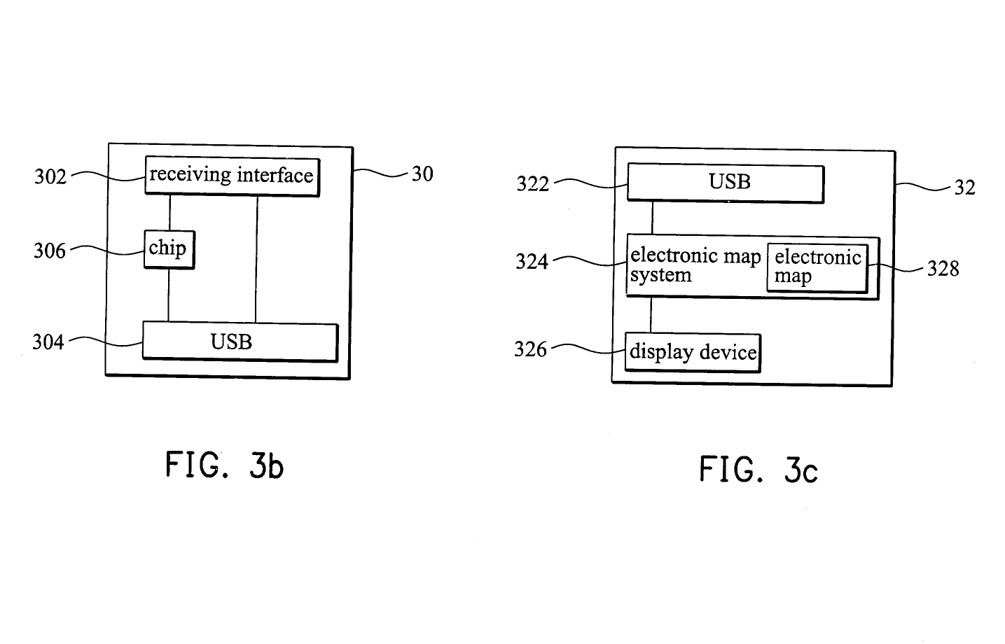

FIG. 3a shows the configuration of the system for receiving GPS signals according to a first embodiment of the present invention. The system comprises a mobile telecommunication device 30 and a terminal device 32. The mobile telecommunication device 30 is connected to the terminal device 32. The mobile telecommunication device 30 has a chip that can support GPS. Thus the mobile telecommunication device 30 can receive a GPS signal. Both the mobile telecommunication device 30 and the terminal device 32 support universal serial bus (USB) protocol. The transmission interface for transmitting information between the mobile telecommunication device 30 and the terminal device 32 is a USB interface. The GPS signal is transmitted from the mobile telecommunication device 30 to the terminal device 32 through a transmission line 34 via the USB (see to FIG. 3b). The GPS signal from the mobile telecommunication device 30 is processed, calculated and displayed in the terminal device 32 (see to FIG. 3c).

FIG. 3b is a block diagram of an example of the mobile telecommunication device of FIG. 3a. The mobile telecommunication device 30 of FIG. 3b is a personal telecommunication device such as a mobile phone. The mobile telecommunication device 30 comprises a receiving interface 302, a universal serial bus (USB) 304 and a chip 306. The receiving interface 302 receives a GPS signal. The USB 304 transmits the GPS signal to the terminal device 32 via the transmission line 34. The chip 306 can support GPS. Thus the mobile telecommunication device 30 can receive the GPS signal and transmit the GPS signal via the USB 304.

FIG. 3c is a block diagram of an example of the terminal device of FIG. 3a. The terminal device 32 of FIG. 3a is a high-performance operational device with large storage and memory capacity such as a personal digital assistant (PDA), a notebook, or a personal computer. The terminal device 32 comprises a universal serial bus (USB) 322, an electronic map system 324 and a display device 326. The USB 322 receives the GPS signal transmitted from the mobile telecommunication device 30. The electronic map system 324 combines the global positioning system signal and an electronic map 328 to produce information in graphic mode, applied to the electronic map 328 and is then displayed on the display device 326.

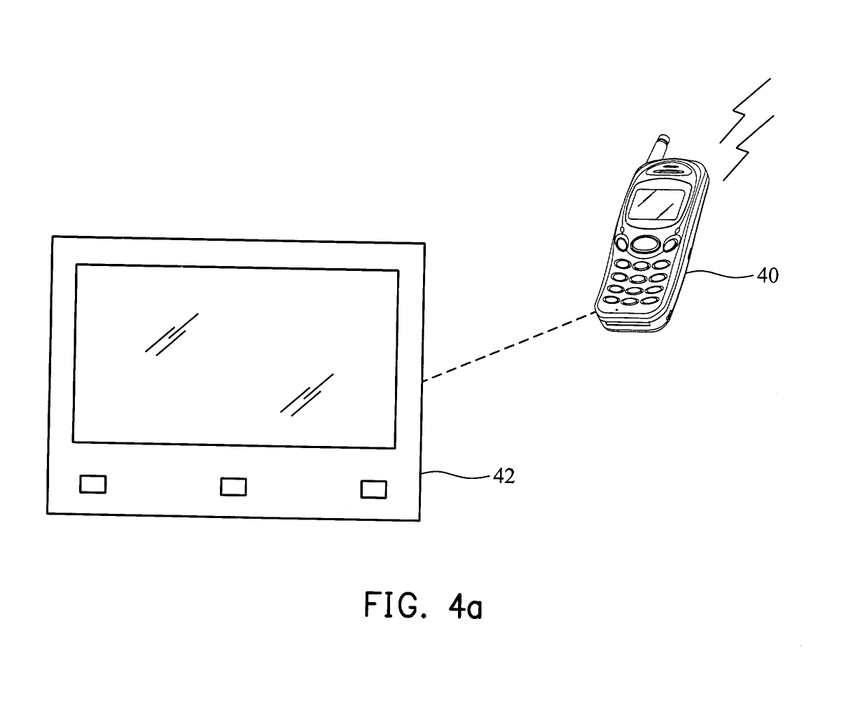

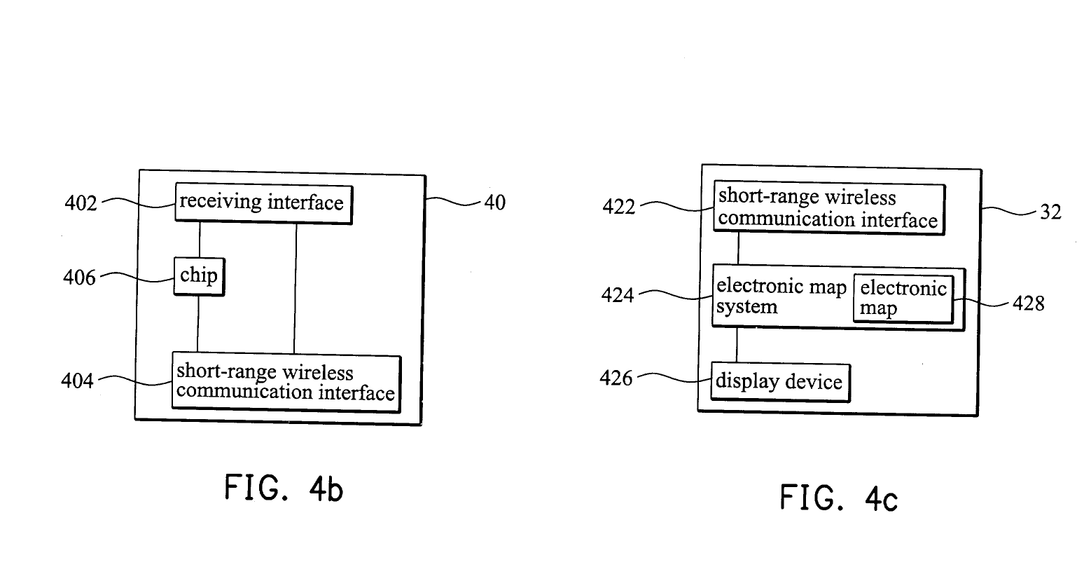

FIG. 4a shows the configuration of the system for receiving GPS signals according to a second embodiment of the present invention. The system comprises a mobile telecommunication device 40 and a terminal device 42. The mobile telecommunication device 40 has a chip that supports GPS, allowing it to receive a GPS signal. Both the mobile telecommunication device 40 and the terminal device 42 support short-range wireless communication capability, such as Bluetooth protocol. The GPS signal is transmitted from the mobile telecommunication device 40 to the terminal device 42 via the wireless interface (see FIG. 4b). The GPS signal from the mobile telecommunication device 40 is processed, calculated and displayed in the terminal device 42 (see to FIG. 4c).

FIG. 4b is a block diagram of an example of the mobile telecommunication device of FIG. 4a. The mobile telecommunication device 40 of FIG. 4b is a personal telecommunication device such as a mobile phone. The mobile telecommunication device 40 comprises a receiving interface 402, a short-range wireless communication interface 404 and a chip 406. The receiving interface 402 receives a GPS signal. The Short-range wireless communication interface 404 transmits the GPS signal to the terminal device 42. The chip 406 can support GPS. Thus the mobile telecommunication device 40 can receive the GPS signal and transmit the GPS signal via the Short-range wireless communication interface 404.

FIG. 4c is a block diagram of an example of the terminal device of FIG. 4a. The terminal device 42 of FIG. 4a is a high-performance operational device with large storage and memory capacity such as a personal digital assistant (PDA), a notebook, or a personal computer. The terminal device 42 comprises a short-range wireless communication interface 422, an electronic map system 424 and a display device 426. The short-range wireless communication interface 422 receives the GPS signal transmitted from the mobile telecommunication device 40. The electronic map system 424 combines the global positioning system signal and an electronic map 428 to produce information in graphic mode, apply it to the electronic map 428 and then display it on the display device 426.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Thus, the scope of the appended claims should be accorded the broadest interpretation so as to encompass all such modifications and similar arrangements.

What is claimed is:

1. A system for receiving global positioning system signal, comprises:
a mobile telecommunication device comprising:
a first receiving interface for receiving a global positioning system signal; and
a transmission interface for transmitting the global positioning system signal; and
a terminal device comprising:
a second receiving interface for receiving the global positioning system signal from the mobile telecommunication device;
an electronic map system comprising an electronic map, combining the global positioning system signal and the electronic map to produce information in graphic mode; and
a display device for displaying the graphic information.

2. The system as claimed in claim 2, wherein the graphic information is applied to the electronic map using the information contained in the GPS signal.

3. The system as claimed in claim 1, wherein the second receiving interface is a universal serial bus and the transmission interface is a universal serial bus.

4. The system as claimed in claim 1, wherein the second receiving interface is a short-range wireless communication interface and the transmission interface is a short-range wireless communication interface.

5. The system as claimed in claim 4, wherein the short-range wireless communication interface utilizes a Bluetooth protocol.

6. The system as claimed in claim 1, wherein the mobile telecommunication device is a mobile phone.

7. The system as claimed in claim 1, wherein the mobile telecommunication device is a personal digital assistant.

8. The system as claimed in claim 1, wherein the terminal device is a notebook.

9. The system as claimed in claim 1, wherein the terminal device is a personal computer.

10. A method for receiving global positioning system signals, comprising steps as follows:
receipt of a global positioning system signal by a mobile telecommunication device;
transmitting the global positioning system signal from the mobile telecommunication device to a terminal device which comprises an electronic map;
combining the global positioning system signal and an electronic map to produce information in graphic mode; and
displaying the graphic information on a display device.

11. The method as claimed in claim 10, wherein the graphic information is applied to the electronic map using the information contained in the GPS signal.

12. The method as claimed in claim 10, wherein the step of transmitting the global positioning system signal from the mobile telecommunication device to a terminal device is via a universal serial bus.

13. The method as claimed in claim 10, wherein the step of transmitting the global positioning system signal from the mobile telecommunication device to a terminal device is via a short-range wireless communication interface.

14. The system as claimed in claim 13, wherein the short-range wireless communication interface utilizes a Bluetooth protocol.

15. The method as claimed in claim 10, wherein the mobile telecommunication device is a mobile phone.

16. The method as claimed in claim 10, wherein the mobile telecommunication device is a personal digital assistant.

17. The method as claimed in claim 10, wherein the terminal device is a notebook computer.

18. The method as claimed in claim 10, wherein the terminal device is a personal computer.
